(19) United States
(12) Patent Application Publication
(10) Pub. No.: US 2021/0170600 A1
(43) Pub. Date: Jun. 10, 2021

(54) HOME ROBOT AND SECURITY MONITORING SYSTEM FOR SMART HOME BY INTERWORKING HOME DEVICE

(71) Applicant: VARRAM SYSTEM CO., LTD., Yuseong-gu (KR)

(72) Inventors: Byung Jo SUH, Yuseong-gu (KR); Kyoung Seok KIM, Yuseong-gu (KR)

(21) Appl. No.: 16/889,891

(22) Filed: Jun. 2, 2020

(30) Foreign Application Priority Data
Dec. 4, 2019 (KR) 10-2019-0159786

(51) Int. Cl. B25J 9/16; B25J 9/00; B25J 13/08; B25J 19/04

(52) U.S. Cl. CPC B25J 9/1674; B25J 9/0003; B25J 13/08; B25J 9/1679; B25J 9/1697; B25J 9/161; B25J 19/04

(57) ABSTRACT

According to the present invention, the further home robot transmits data of the plurality of IoT devices based on a camera mounted on a robot, a communication unit, a storage unit storing internal map data, and device information and location information of the plurality of IoT devices installed in a home through communication with the IoT device, and moves to a point where abnormal data is generated when the data of the further plurality of IoT devices are abnormal The processor provided is included.

### TECHNICAL FIELD

The present disclosure relates to a home robot and a method for interworking a plurality of mobile home devices and, more specifically, to a method for controlling a robot capable of active smart home service by collecting data transmitted from a home device.

### BACKGROUND ART

Recently, smart home IoT devices are constituted a smart home network environment in the situation that interest and technology development for smart homes are rapidly increasing.

Especially, the interest of American consumers in smart home is increasing, so the related market is expected to grow greatly. Smart home includes smart home solutions and various products and services that control smart devices, which are expected to have a positive impact on many industries.

As the complex smart home environment is expected to be built by the development of the Internet of Things (IoT), various companies such as home appliances, communication, security, and utilities are entering the market. Besides, the interest of various companies is increasing. Also, the construction of a smart home platform is not only linked and controlled with related products, but also includes voice and motion recognition, and virtual reality and home robots. It seems that consumers should make substantial purchases through smart home products.

The development of home robots along with smart home is also growing. Home robots are frequently appearing in CES in recent years, and since the cleaning robot of iRobot has emerged, robots have been acting as partners rather than as housekeepers.

In the future, the most innovative areas in the smart home are expected to be home robots and home social robots that will serve as secretaries.

### DISCLOSURE

### Technical Problem

The disclosed present invention relates to a method for controlling a robot, which monitors various home environments and abnormalities through a home robot collecting data from a home device installed in a home and provides various services through the same. Especially, when there are elderly people, children, and companion animals who need home care, the robot actively monitors these care objects and provides a method for the robot to notify the guardian when a safety accident occurs.

### Technical Solution

According to an embodiment of the present invention, the home robot transmits data of the plurality of IoT devices based on the home robot collecting device information and location information of the plurality of IoT devices installed in a home and a storage unit storing the communication unit and the map data, and the home of the robot through communication with the IoT device. The processor offering the in-home safety service to the image shooting and electrical transmission is included.

The home robot further includes an IoT-based wearable sensor worn by a care object along with the IoT device. When the processor recognizes the abnormal state of the care object in the wearable sensor and transmits the recognition result to the home robot, the processor moves to an abnormal state generation area of the object based on the transmitted data to photograph and transmit the state of the object.

The processor moves the home to the home installed at first, constructs a home environment map, separates the room and living room with the input of the user, maps the location where the home IoT devices installed at the home are installed through mapping, collects the type, quantity and location information of the IoT device (‘home device’) installed at the home, and transmits data transmitted from the images and IoT devices to the server Continuously, the unusual condition generating in the home environment is confirmed.

The processor moves to a room or location where an abnormal state occurs based on the mapped position when a strange state value is confirmed from IoT devices, and takes a picture of the abnormal state and transmits the abnormal state to the server.

According to another embodiment of the present invention, the smart home safety monitoring system comprises: a camera mounted on a robot; a communication unit; a storage unit storing internal map data; and a home robot collecting device information and location information of a plurality of IoT devices installed in the home through communication with the IoT device. The present invention comprises: a home robot including a processor moving to a point where abnormal data is generated to provide a home safety service by image photographing and transmission; and a server managing information received from the home robot.

### Advantageous Effects

According to the disclosed present invention, the safety service about the dangerous situation can be provided to the smart home care system which possessively can deal with the situation generated through the home robot and plurality of device couplings in assumption.

### DESCRIPTION OF DRAWINGS

FIG. 1 is a drawing to explain a smart home safety monitoring system through a home robot and home device interlocking according to an embodiment of the present invention.

FIG. 2 is a block diagram of a home robot according to an embodiment of the present invention.

FIG. 3 is a flow diagram for identifying the abnormal state of the home environment using the home robot and explaining the process of managing it in real-time.

### DETAILED DESCRIPTION OF THE PREFERRED EMBODIMENT

Hereinafter, the present invention will be described in detail regarding the accompanying drawings.

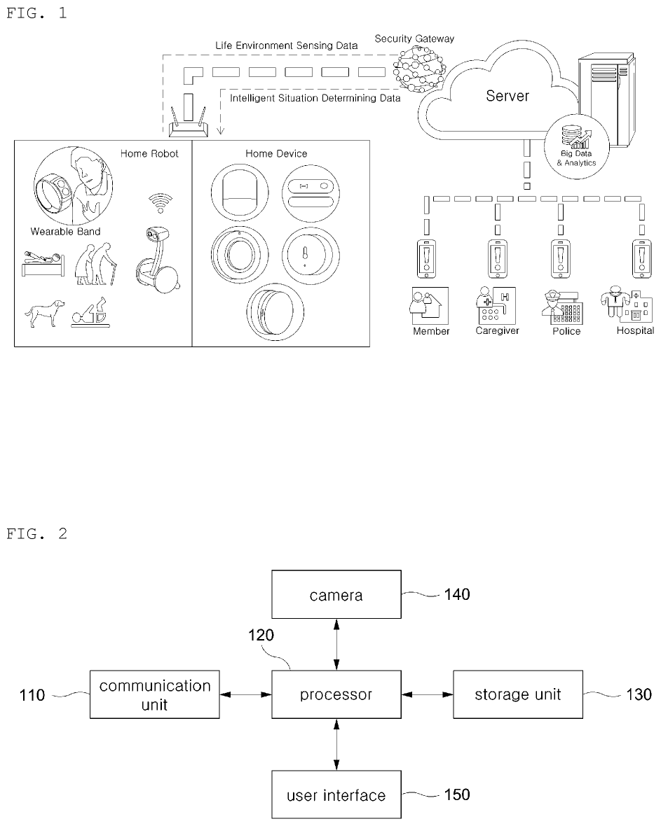

FIG. 1 is a drawing to explain a smart home safety monitoring system through a home robot and home device interlocking according to an embodiment of the present invention.

In FIG. 1, there may be numerous IoT mechanisms in the home, such as home robots that can move themselves and several home sensing devices installed in the home environment. IoT means a technology that connects the Internet with sensors and communication functions in various objects, so there is no limit to the types of IoT devices that can exist in the home.

On the other hand, the home IoT environment can include an IoT hub device, wherein the IoT devices can be controlled and managed by being linked to a home robot.

The present invention can perform an operation corresponding to a user by receiving a voice command of the user while the home robot performs the role of an IoT hub device as shown in FIG. 1, monitors the home environment while moving the home environment by itself, and operates to check an abnormal state while collecting IoT sensor data.

Conventional fixed type IoT hub devices can also manage and control connected IoT devices. However, the conventional IoT hub device does not know where each IoT device is located in the actual home, and it only transmits and receives information to each device, so there is a limit to providing IoT device location-based service.

Therefore, the mobile home robot accurately grasps its position and obtains accurate location information of IoT devices in the home, thereby enabling active service execution, and enabling the user to grasp and transmit an emergency or an abnormal situation in real-time to a management system if the mobile home robot is generated.

Mobile home robots can move their positions by themselves, not being fixed in one place. Therefore, the present invention can generate or update the map data of the house while moving throughout the house, generate location information of the IoT device installed in the house, and map the generated location information to the map data to manage the map data. The home robot obtains the location information of IoT devices installed at each space the information is moved the IoT devices are installed in the different space divided in the edge angle and it can map in map data.

Also, the home robot can periodically update map data while moving in-home. The location information of the IoT device is also updated with the update of map data, so that the latest location information changed even if the location of the IoT in which the user is installed is changed can be managed.

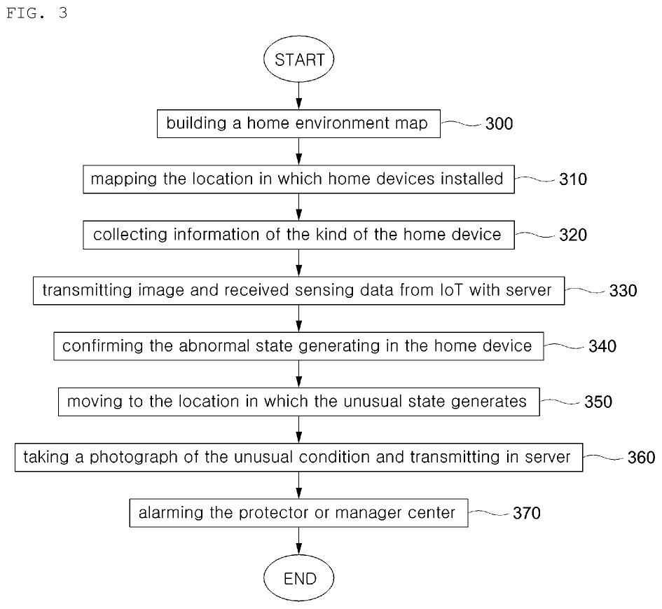

FIG. 2 is a block diagram of a home robot according to an embodiment of the present invention.

Referring to FIG. 2, the home robot (100) may include a communication unit (110), a processor (120), a storage unit (130), a camera (140), and a user interface (150).

The communications unit (110) is controlled by the processor (120) and various types of external devices and communications can be performed according to all kinds of wired and wireless communications methods. For example, the communications unit (110) can perform all kinds of servers and communications through networks including the internet, etc. In addition, the communication unit (110) may communicate with the IoT devices (11 to 16) or the IoT hub device (10) in the home in various local area communication methods.

The storage (130) stores all kinds of programs for the operation of the move mode home robot (100) and data. In particular, the storage unit (130) comprises: home map data; device information (e.g., model name, type, serial number, MAC address, function, related URL) of the home installed IoT devices (e.g., IoT devices include a fixed IoT hub device); location information of the IoT devices generated by the processor (120) (e.g., coordinate information, size information, direction information, installation information, etc. The map data in which the location information of IoT devices is mapped, the semantic information related to the location information of IoT devices, map data, etc. can be stored. In addition, the storage unit (130) can store various databases and voice recognition modules required to provide interactive services to the user. Accordingly, the processor (120) can provide an interactive service, and the storage (130) can store a program module required for determining a situation of a user.

The camera (140) takes a photograph of the external image it receives the control of the processor (120). In particular, the camera (140) can photograph the surrounding image while the mobile home robot (100) moves in the house. The camera (140) may also be photographed by tracking the user under control of the processor (120), such that the photographed image data may be provided to the processor (120).

The user interface (150) is the component for the user to interact with the mobile home robot (100). The user inputs the command to the mobile home robot (100) through the user interface (150) and can recognize information outputted by the mobile home robot (100). To this end, the user interface (150) may include various user inputs and output interfaces.

The processor (120) controls the overall operation of the move mode home robot (100). In particular, the processor (120) can generate position information of each of the plurality of IoT devices based on the device information of the plurality of Internet Of things devices installed in the home and the image photographed through the camera (140) while the mobile home robot moves throughout the home.

Specifically, the processor (120) can obtain device information of a plurality of IoT devices installed in the premises. For example, the processor (120) may receive device information for a plurality of IoT devices installed in the premises from an external IoT hub device (10) via a communication unit (110). Generally, the IoT hub device (10) manages IoT devices installed in the home, thereby storing device information of IoT devices. Therefore, when the processor (120) has an IoT hub device (10), the processor (120) can obtain device information of the IoT devices installed in the home by requesting device information to the IoT hub device (10).

Also, when the mobile home robot (100) operates as an IoT hub device, the IoT devices provide device information to the mobile home robot (100) when installed and registered. Therefore, the processor (120) can store the device information received from each IoT device in the storage unit (130) and can use the device information of the IoT devices stored in the storage unit (130) as necessary.

It includes an IoT-based wearable sensor that is worn on a care object (such as a person, an animal, etc.), and the wearable sensor can recognize the abnormal state of the care object and transmit it to the home robot (100). It moves based on data transmitted from the wearable sensor to the abnormal state generation region of the object and it takes a photograph of the state of the object and the home robot (100) can transmit.

FIG. 3 is a flow diagram for identifying the abnormal state of the home environment using the home robot and explaining the process of managing it in real-time.

Referring to FIG. 3, the home robot builds a home environment map while moving the first installed premises and separates the room and living room with the input of the user (300).

The home robot maps the location in which home IoT devices installed at the premises are installed through mapping. (310).

The kind of the IoT device (‘home device’) installed at home robot is the house and quantity and location information are collected (320).

While moving by itself, the home robot transmits data transmitted from image and IoT devices with server (330).

The home robot continuously confirms the abnormal state generating in the home environment (340).

If the strange state value is confirmed from IoT devices, the home robot moves to the room or the location in which the unusual state generates based on the mapped location (350). It takes a photograph of the unusual condition and the home robot transmits in server (360).

The home robot informs the abnormal state to the terminal of the management center and protector. In that way the protector bottom manager can grasp the situation on a real-time basis (370).

This real-time active safety monitoring service can solve the in-home life safety which can occur unexpectedly by the coupling of home robot and IoT device.

The embodiments described above may be configured by selectively combining all or some of the embodiment such that various modifications may be made.

It should also be noted that the embodiments are for the purpose of illustration and not for the purpose of limitation. In addition, it will be understood by those of ordinary skill in the art that various embodiments are possible within the scope of the technical idea of the present invention.

1. A home robot, comprising
a camera mounted the home robot;
a communication unit;
a memory storing map data about inner home; and
a processor transmitting a data of a multiple IOT devices based on device information and a location information of the multiple IOT devices in the home collected by the home robot communicating through the multiple IOT devices, moving to the point where abnormal data occur if the data of the multiple IOT devices are an abnormal condition value and obtaining and transmitting an image.

2. The home robot of claim 1, further comprising wearable sensor wearing a care object with a IOT device based on IOT Technology,
wherein the wearable sensor recognizing an abnormal condition of the care object and a transmitting recognized result to the home robot, and the processor moving to the point where abnormal data occur based on the transmitted recognized result and obtaining and transmitting an image about condition of the care object.

3. The pet training robot of claim 1, the further processor, the home robot, constructs a home environment map while moving the first installed house, separates the room and living room with the input of a user, maps the location where home IoT devices installed in the house are installed through mapping, collects the type, quantity and location information of the IoT device (‘home device’) installed in the house, A home robot that transmits data transmitted from the IoT devices to a server and continuously checks an abnormal state that can occur in a home environment.

4. The pet training robot of claim 1, the further processor,
When a strange state value is confirmed from IoT devices, the home robot moves to the room or location where an abnormal state occurs based on the mapped location, photographs the abnormal state, and transmits it to the server.

5. The further home robot including a camera mounted on the robot, a communication unit, a storage unit storing in-map data, and a processor transmitting data of the IoT devices based on the home robot collecting device information and location information of the IoT devices installed in the home through communication with the IoT devices, and moving to a point where abnormal data is generated when the data of the IoT devices are abnormal And
A smart home safety monitoring system through home device interlocking including a server for managing information received from the further home robot.
